(19) United States
(12) Patent Application Publication
(10) Pub. No.: US 2023/0126925 A1
(43) Pub. Date: Apr. 27, 2023

(54) VIRTUAL FOREMAN DISPATCH PLANNING SYSTEM

(71) Applicant: PIMQ Co., Ltd., Taipei City (TW)

(72) Inventor: Hsiang-Chun Lin, Taipei City (TW)

(73) Assignee: PIMQ Co., Ltd., Taipei City (TW)

(21) Appl. No.: 17/709,468

(22) Filed: Mar. 31, 2022

(30) Foreign Application Priority Data
Oct. 25, 2021 (TW) 110139575

(51) Int. Cl. G06Q 10/06; G05B 23/02; G05B 19/418; G06N 5/02

(52) U.S. Cl. CPC G06Q 10/063116; G05B 23/0283; G05B 19/4185; G06N 5/02

(57) ABSTRACT

The present invention provides a virtual foreman dispatch planning system installed in a host in a factory, including: a knowledge graph unit, a matching unit and a recommendation unit. The knowledge graph unit has a first memory and a second memory which are connected with each other, and constructs and stores structural information including checking nodes, maintenance nodes and edges. The matching unit includes a neural network classifier that adopts semi-supervised learning method to retain original structural information, and downgrades the dimension of a continuous lantent space so that the continuous lantent space becomes a vector space, making nodes with more similar structures be closer in distance in the vector space. Through the K-Nearest Neighbor algorithm, the recommendation unit calculates the node of the maintenance record nearest to the vector space which is used as the dispatched manpower required for recommendation, so as to achieve the optimal dispatching effect.

### BACKGROUND OF THE INVENTION

### Technical Field of the Invention

The present invention relates to a virtual foreman dispatch planning system, and more particularly, to a virtual foreman dispatch planning system used in factories, which can online match the abnormal or faulty machines to match a suitable maintenance operator, and then recommend the required dispatch manpower through wireless notification.

### Description of Related Art

The factories nowadays have introduced different digitalized systems to store operation records and machine parameters of factory operator. However, so far most of the data are merely being collected, without further being used to improve the operation efficiency of factory machines and operator.

In recent years, with the development of machine learning algorithms and other tools, many companies have begun to use parameters to predict the health status of machines, including normal, abnormal or failure, and further manage the machines and operator in factories after obtaining the information.

These models, however, should be regarded as classifiers that only solve simple Boolean problems, and are only used to predict whether they are abnormal or not. As to whom should be sent to deal with the abnormal situation, traditional factories are highly dependent on the foreman to dispatch and deal with manpower on the production line according to experiences from the past or the conditions on the site.

After the manpower is dispatched, how to address the problems and which methods should be used to fix the problems are based on passed down technician experiences and the self trial-and-error experiences of the dispatched operator, which means there is generally no systematic or robust method to properly solve the problems.

Aforementioned two complicated problems, i.e., whom should be dispatched and which method should be chosen to properly solve the problems, remain unsolved. In addition, with the imminent retirement of the experts who master the factory know-how in industries, there is going to be a great technical gap in businesses. Hence, the objective of the present application is to provide a novel method to solve the above two problems.

In view of the above, the inventor of the present application provides the present invention based on many years working experiences combining the design of network and communication.

### SUMMARY OF THE INVENTION

The present invention relates to a virtual foreman dispatch planning system, and more particularly, to a virtual foreman dispatch planning system used in factories, which can online match the abnormal or faulty machines to match a suitable maintenance operator, and then recommend the required dispatch manpower through wireless notification, so as to realize the most appropriate dispatching effect.

To reach the above objective, the present invention provides a virtual foreman dispatch planning system installed in a host in a factory and comprising a knowledge graph unit, a matching unit and a recommendation unit. The knowledge graph unit has a first memory and a second memory connected with each other, wherein the first memory stores information of components of each machine, checking items of said each machine, and checking records of operator, as checking nodes (nodes 1). The second memory stores information of said each machine and the components of said each machine, and stores a maintenance record of operator, as maintenance nodes (nodes 2). Each of the checking nodes and maintenance nodes are associated to be linearly connected and stored as edges, wherein if checking items or maintenance items of a same component belong to different operator, said different operator are jointly connected to the same component to form structural information.

The matching unit is connected with the knowledge graph unit and comprising at least one neural network classifier, wherein regarding the structural information of the checking nodes, the maintenance nodes and edges, the neural network classifier adopts a semi-supervised learning method (e.g., the SkipGram algorithm) to retain the structural information stored in the first memory and the second memory, and downgrade the dimension of the structural information to a continuous lantent space to serve as a vector space, making nodes with more similar structures closer to each other in distance in the vector space; and

The recommendation unit is connected with the matching unit and comprises at least one microprocessor, wherein the recommendation unit adopts a K-nearest neighbor (KNN) algorithm to calculate similarity by calculating distances, finding neighbors and performing classification, provides a certain requested checking node or maintenance node, and searches for a nearest node in the vector space from the maintenance record as a recommended optimal dispatch.

According to an embodiment, contents of the checking items and maintenance items stored in the first memory and the second memory come from components of said each machine, and at least comprise a motor, heater, indicator light, material inlet, material outlet, etc.

According to an embodiment, the virtual foreman dispatch planning system according to claim 1, wherein a neural network classifier of the matching unit has an optimization area, and the optimization area optimizes a first-order similarity and second-order similarity through an optimization objective algorithm, wherein the first-order similarity is defined by referring nodes adjacent to a given node in the structural information as first-order neighbors; the second-order similarity is defined by referring nodes having a common first-order neighbor as second-order neighbors; and based on following equations of the optimization objective algorithm, vector spaces of nodes on the structural information belonging to the first-order neighbors or the second-order neighbors are closer to one another, in comparison with vector spaces of nodes on the structural information not belonging to the first-order neighbors or the second-order neighbors;

$${O}_{1} = {\sum }_{i = 1}^{N} ( {\sum }_{{v}_{{}_{j} ∈ {N}_{1} ( {v}_{i} )}}^{N} \frac{1}{1 + exp ( - {z}_{{i}_{{}_{}}}^{{T}^{}} {z}_{j} )} + {\sum }_{{v}_{{}_{j} ∼ {P}_{1} ( {v}_{i} )}}^{N} \frac{1}{1 + exp ( {z}_{{i}_{{}_{}}}^{{T}^{}} {z}_{j} )} )$$

wherein N₁ (vi) represents a set of vi first-order neighbors, P₁(vi) represents distribution of non-vi first-order neighbors, and zi and zj represent embedding vectors of nodes vi and vj respectively.

According to an embodiment, the virtual foreman dispatch planning system according to claim 1, wherein distances in the KNN algorithm of the recommendation unit are calculated by: providing a node to be evaluated, calculating distances between the node to be evaluated and each node in the structural information by using Euclidean distance, Manhattan distance and cosine of included angle respectively, so as to measure the dissimilarity between objects, wherein the Euclidean distance is used for relational data; and cosine of included angle is used to calculate similarities for text classification.

According to an embodiment, the virtual foreman dispatch planning system according to claim 1, wherein the KNN algorithm of the recommendation unit selects several nearest nodes as neighbors of a node to be evaluated, and the KNN algorithm adopts cross-validation and empirical rules, wherein one part of calculated values is used as samples for a training set of the neural network classifier of the matching unit; another part of the calculated values is used as a testing set, and several nearest nodes are selected by the empirical rules; said several nearest nodes constantly are adjusted from the beginning till the end to optimize sample classification; when the sample classification is optimal, values of said nearest nodes are selected values; and distances between each of the samples in the entire training set and the node to be evaluated are calculated to select several nearest nodes as nearest neighbors.

According to an embodiment, the virtual foreman dispatch planning system according to claim 1, wherein the classification in the KNN algorithm of the recommendation unit determines the category in which said nearest nodes shows up most often as a prediction category of a node to be evaluated; the classification in the KNN algorithm comprises comprehensive voting decision and weighting method, wherein the voting decision is defined by that the minority obeys the majority, and the category with most number of nodes in the neighbors of several nearest nodes is selected as the chosen category; and the weighted voting rule is to weight votes of the neighbors according to the magnitude of distance, and the closer the distance, the greater the weight.

### BRIEF DESCRIPTION OF THE DRAWINGS

FIG. 1 is a schematic diagram illustrating the connection between the host, the operator system and a machine in a factory, according to a virtual foreman dispatch planning system of the present invention.

FIG. 2 is an architecture diagram of the virtual foreman dispatch planning system of the present invention.

FIGS. 3-5 are diagrams illustrating checking records and a maintenance record stored in a first memory and a second memory of a knowledge graph unit of the virtual foreman dispatch planning system of the present invention.

FIGS. 6-7 are diagrams illustrating the structural information of checking nodes, maintenance nodes and edges constructed by the matching unit of the virtual foreman dispatch planning system of the present invention.

### DETAILED DESCRIPTION OF THE INVENTION

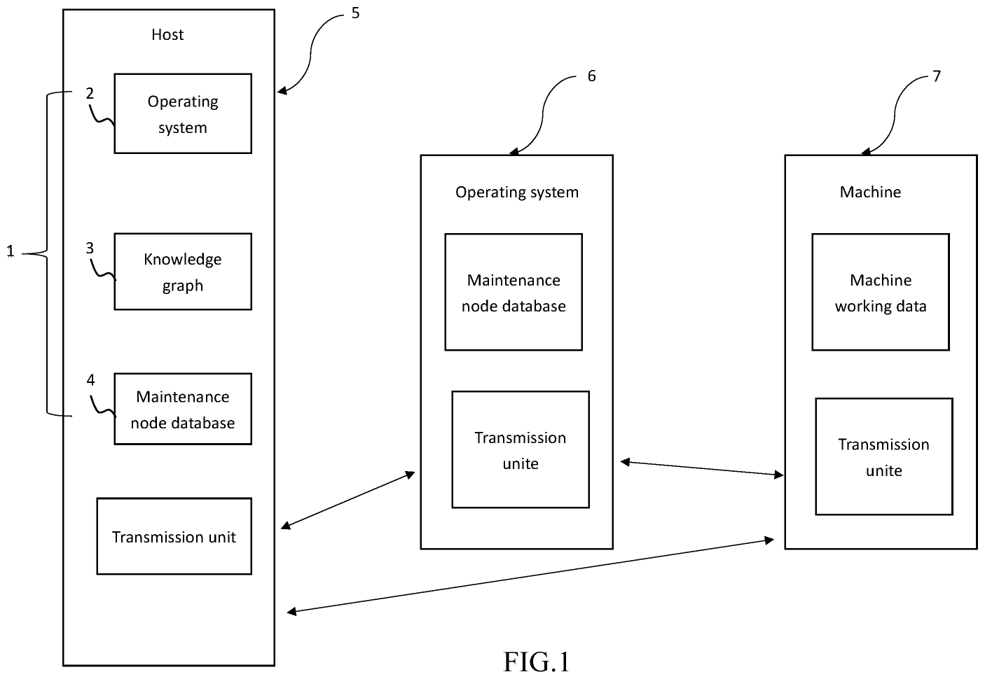

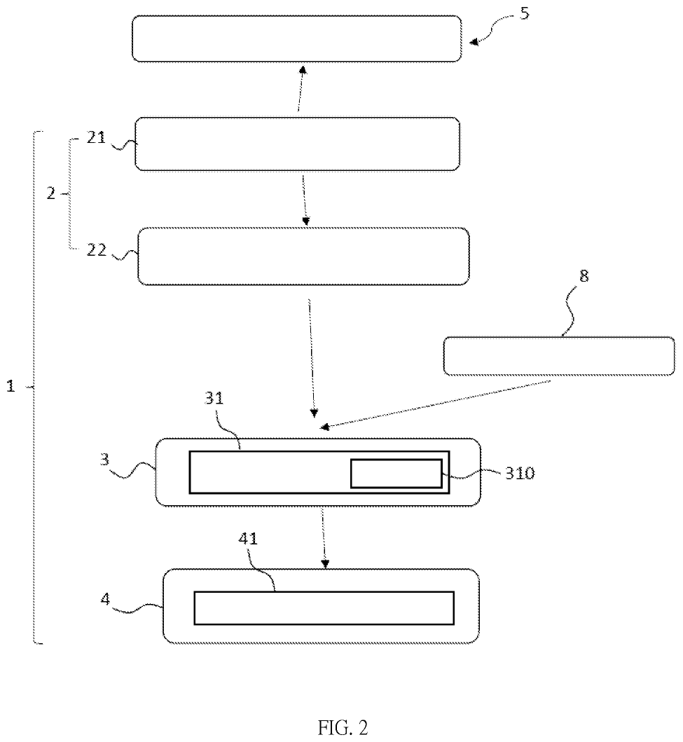

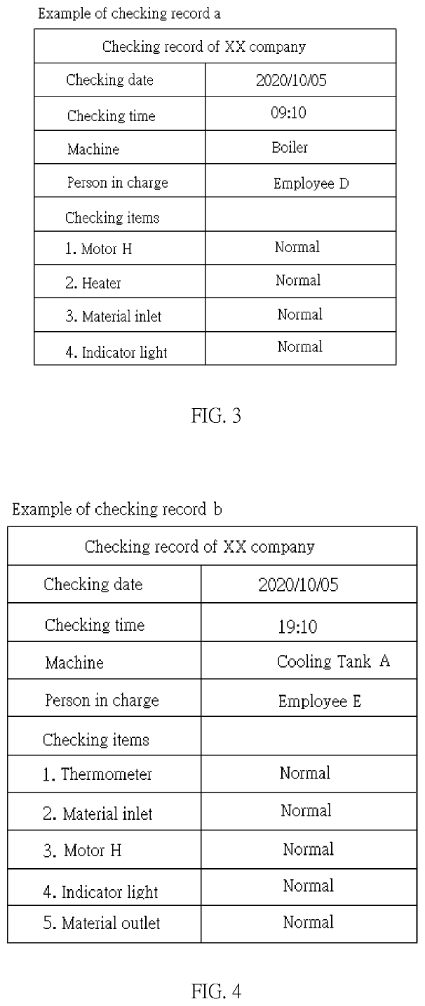

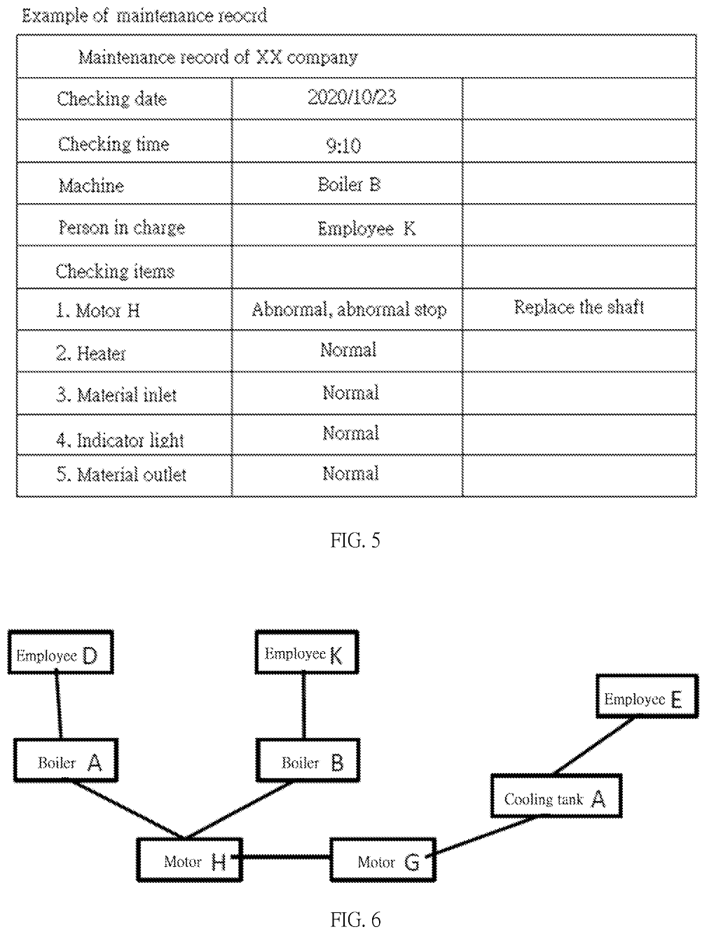

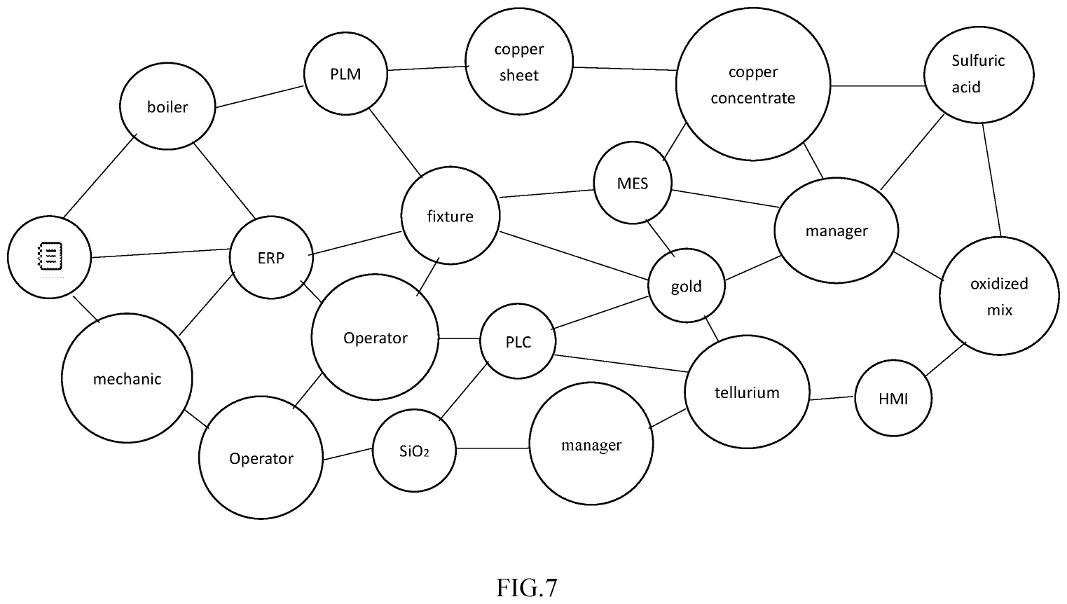

Please refer to FIG. 1, which is a schematic diagram illustrating the connection between the host, the operator system and a machine in a factory, according to a virtual foreman dispatch planning system of the present invention. As shown in the figure, the virtual foreman dispatch planning system 1 of the present invention is assembled in the host 5 in the factory, and the operator system 6 is coupled with the host 5, which can transmit basic information of the operator to the host 5. The machine 7 of each machine in the factory is also connected with the host 5, which can transmit the checking records and maintenance records of each machine, and even the messages of malfunction to the host 5. Referring to FIG. 2, the virtual foreman dispatch planning system 1 includes a knowledge graph unit 2, a matching unit 3, and a recommendation unit 4, wherein the knowledge graph unit 2 has a first memory 21 and a second memory 22 which are connected with each other, wherein the first memory 21 stores each machine and components thereof, checking items and checking records of related operators as the checking node (node 1). Please refer to FIGS. 3 and 4, the contents of the checking items stored in the first memory 21 come from the components of each machine, including a motor, heater, indicator light, material inlet, material outlet, etc. The second memory 22 stores the maintenance items and maintenance records of related operators of each machine in the factory as a maintenance node (node 2). Please refer to FIG. 5, the contents of the maintenance items stored in the second memory 22 also come from the components of each machine, including a motor, heater, indicator light, material inlet, material outlets, etc. Furthermore, please refer to FIG. 6 and FIG. 7, each checking node and maintenance node are linearly connected and stored as an edge. For example, the checking items or maintenance items of the same component may belong to different operators (such as Employee D and Employee K shown in FIGS. 3, 4 and 6, while Employee E is irrelevant), and the different operators are connected to the same component to form structural information.

Please refer back to FIG. 2, the matching unit 3 is connected with the knowledge graph unit 2, and includes a neural network classifier 31, which adopts a semi-supervised learning method (e.g., the SkipGram algorithm) to retain the original structural information of the structural information stored in the first memory 21 and the second memory 22 that includes the checking nodes, maintenance modes and edges, in order to downgrade the dimension of the structural information to a continuous lantent space to serve as a vector space, making nodes with more similar structures closer in distance in the vector space. In addition, the neural network classifier 31 of the matching unit 3 has an optimization area 310. The optimization area 310 optimizes the first-order similarity and the second-order similarity through the optimization target algorithm. The first-order similarity is defined by referring nodes adjacent to a given node in the structural information as first-order neighbors. The second-order similarity is defined by referring nodes having a common first-order neighbor as second-order neighbors. Based on following equations of the optimization objective algorithm, vector spaces of nodes on the structural information belonging to the first-order neighbors or the second-order neighbors are closer to one another, in comparison with vector spaces of nodes on the structural information not belonging to the first-order neighbors or the second-order neighbors. The equations of the optimization objective algorithm are as follows.

$${O}_{1} = {\sum }_{i = 1}^{N} ( {\sum }_{{v}_{{}_{j} ∈ {N}_{1} ( {v}_{i} )}}^{N} \frac{1}{1 + exp ( - {z}_{{i}_{{}_{}}}^{{T}^{}} {z}_{j} )} + {\sum }_{{v}_{{}_{j} ∼ {P}_{1} ( {v}_{i} )}}^{N} \frac{1}{1 + exp ( {z}_{{i}_{{}_{}}}^{{T}^{}} {z}_{j} )} )$$

wherein N₁ (vi) represents a set of vi first-order neighbors, P₁(vi) represents distribution of non-vi first-order neighbors, and zi and zj represent embedding vectors of nodes vi and vj respectively.

As shown in FIG. 2, the recommendation unit 4 is connected with the matching unit 3, and at least includes a microprocessor 41 which adopts the K-nearest neighbor (KNN) algorithm (hereinafter KNN algorithm) to perform similarity calculation by calculating distance, finding neighbors and performing classification. In addition, regarding a certain requested checking node or maintenance node, the KNN algorithm searches for the closest node of maintenance record in vector space through calculation as the recommended most appropriate dispatcher. Further, distances in the KNN algorithm of the recommendation unit 4 are calculated by: providing a node to be evaluated, calculating distances between the node to be evaluated and each node in the structural information by using Euclidean distance, Manhattan distance and cosine of included angle respectively, so as to measure the dissimilarity between objects, wherein the Euclidean distance is used for relational data; and cosine of included angle is used to calculate similarities for text classification. Furthermore, the KNN algorithm of the recommendation unit 4 selects several nearest nodes as neighbors of a node to be evaluated, and the KNN algorithm adopts cross-validation and empirical rules, wherein one part of calculated values is used as samples for a training set of the neural network classifier of the matching unit; another part of the calculated values is used as a testing set, and several nearest nodes are selected by the empirical rules; said several nearest nodes constantly are adjusted from the beginning till the end to optimize sample classification; when the sample classification is optimal, values of said nearest nodes are selected values; and distances between each of the samples in the entire training set and the node to be evaluated are calculated to select several nearest nodes as nearest neighbors. Moreover, the classification in the KNN algorithm of the recommendation unit 4 determines the category in which said nearest nodes shows up most often as a prediction category of a node to be evaluated; the classification in the KNN algorithm comprises comprehensive voting decision and weighting method, wherein the voting decision is defined by that the minority obeys the majority, and the category with most number of nodes in the neighbors of several nearest nodes is selected as the chosen category; and the weighted voting rule is to weight votes of the neighbors according to the magnitude of distance, and the closer the distance, the greater the weight.

As mentioned above, in the virtual foreman dispatch planning system 1 of the present invention, the neural network classifier 31 of the matching unit 3 can be continuously trained and learn, so that the KNN algorithm of the recommendation unit 4 can calculate to search for the closet node of the maintenance record in vector space, meaning it can be used in the factory to provide dispatch planning for abnormal or faulty machines. That is, once there is an abnormal or faulty machine in the factory, the abnormal or faulty machine sends out the abnormal or faulty message 8 through the operator's operation on the operator system 6 (refer to FIG. 2). Through the neural network classifier 31 of the matching unit 3, the structural information constructed by the knowledge graph unit 2 is downgraded to a continuous lantent space to serve as a vector space, so that the closer the nodes with similar structures are, the closer the distance in the vector space is. Then, through the KNN algorithm of the recommendation unit 4, the nearest node of the maintenance record in the vector space is calculated to match an appropriate maintenance operator. Next, through wireless notification, the required dispatching manpower is recommended to the operator's host 6, so that the manpower with veteran experience can be dispatched to achieve the best dispatching effect.

To sum up, the virtual foreman dispatch planning system of the present invention can ensure the innovative purpose and meet the requirements of patent applications. However, what are described above are merely preferred embodiments of the present invention. Modifications and changes made according to the present invention shall fall into the scope of this patent application.

What is claimed is:

1. A virtual foreman dispatch planning system, installed in a host in a factory and comprising:
a knowledge graph unit having a first memory and a second memory connected with each other, wherein the first memory stores information of components of each machine, checking items of said each machine and checking records of an operator, as checking nodes; the second memory stores information of said each machine and the components of said each machine and stores a maintenance record of the operator, as maintenance nodes; and each of the checking nodes and maintenance nodes are associated in order to be linearly connected and stored as edges, wherein if the checking items or maintenance items of a same component belong to different operators, said different operators are jointly connected to the same component to form structural information;
a matching unit connected with the knowledge graph unit and comprising at least one neural network classifier, wherein regarding the structural information of the checking nodes, the maintenance nodes and edges, the neural network classifier adopts a semi-supervised learning method to retain the structural information stored in the first memory and the second memory, and downgrade the dimension of the structural information to a continuous lantent space to serve as a vector space, making nodes with more similar structures closer to each other in distance in the vector space; and
a recommendation unit connected with the matching unit and comprising at least one microprocessor, wherein the recommendation unit adopts a K-nearest neighbor (KNN) algorithm to calculate similarity by calculating distances, finding neighbors and performing classification, provides a certain requested checking node or maintenance node, and searches for a nearest node in the vector space from the maintenance record as a recommended optimal dispatch.

2. The virtual foreman dispatch planning system according to claim 1, wherein contents of the checking items and maintenance items stored in the first memory and the second memory come from the components of said each machine, and at least comprise a motor, heater, indicator light, material inlet and material outlet.

3. The virtual foreman dispatch planning system according to claim 1, wherein a neural network classifier of the matching unit has an optimization area, and the optimization area optimizes a first-order similarity and second-order similarity through an optimization objective algorithm, wherein the first-order similarity is defined by referring nodes adjacent to a given node in the structural information as first-order neighbors; the second-order similarity is defined by referring nodes having a common first-order neighbor as second-order neighbors; and based on following equations of the optimization objective algorithm, vector spaces of nodes on the structural information belonging to the first-order neighbors or the second-order neighbors are closer to one another, in comparison with vector spaces of nodes on the structural information not belonging to the first-order neighbors or the second-order neighbors;
$${O}_{1} = {\sum }_{i = 1}^{N} ( {\sum }_{{v}_{{}_{j} ∈ {N}_{1} ( {v}_{i} )}}^{N} \frac{1}{1 + exp ( - {z}_{{i}_{{}_{}}}^{{T}^{}} {z}_{j} )} + {\sum }_{{v}_{{}_{j} ∼ {P}_{1} ( {v}_{i} )}}^{N} \frac{1}{1 + exp ( {z}_{{i}_{{}_{}}}^{{T}^{}} {z}_{j} )} )$$
wherein N₁ (vi) represents a set of vi first-order neighbors, P₁(vi) represents distribution of non-vi first-order neighbors, and zi and zj represent embedding vectors of nodes vi and vj respectively.

4. The virtual foreman dispatch planning system according to claim 1, wherein distances in the KNN algorithm of the recommendation unit are calculated by: providing a node to be evaluated, calculating distances between the node to be evaluated and each node in the structural information by using Euclidean distance, Manhattan distance and cosine of included angle respectively, so as to measure the dissimilarity between objects, wherein the Euclidean distance is used for relational data; and cosine of included angle is used to calculate similarities for text classification.

5. The virtual foreman dispatch planning system according to claim 1, wherein the KNN algorithm of the recommendation unit selects several nearest nodes as neighbors of a node to be evaluated, and the KNN algorithm adopts cross-validation and empirical rules, wherein one part of calculated values is used as samples for a training set of the neural network classifier of the matching unit; another part of the calculated values is used as a testing set, and several nearest nodes are selected by the empirical rules; said several nearest nodes constantly are adjusted from the beginning till the end to optimize sample classification; when the sample classification is optimal, values of said nearest nodes are selected values; and distances between each of the samples in the entire training set and the node to be evaluated are calculated to select several nearest nodes as nearest neighbors.

6. The virtual foreman dispatch planning system according to claim 1, wherein the classification in the KNN algorithm of the recommendation unit determines the category in which said nearest nodes shows up most often as a prediction category of a node to be evaluated; the classification in the KNN algorithm comprises comprehensive voting decision and weighting method, wherein the voting decision is defined by that the minority obeys the majority, and the category with most number of nodes in the neighbors of several nearest nodes is selected as the chosen category; and the weighted voting rule is to weight votes of the neighbors according to the magnitude of distance, and the closer the distance, the greater the weight.
